(19) United States
(12) Patent Application Publication
(10) Pub. No.: US 2003/0122407 A1
(43) Pub. Date: Jul. 3, 2003

(54) Removable vehicle seat

(76) Inventors: Michael Boyd, Detroit, MI (US); Matthew B. Norris, Harper Woods, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/035,007

(22) Filed: Dec. 28, 2001

(51) Int. Cl. B60N 2/00

(52) U.S. Cl. 297/130; 297/440.22; 297/256.16

(57) ABSTRACT

A vehicle seat assembly includes a releasable portable seat for use outside of the vehicle. The seat assembly includes a seat back and a seat bottom attached to the seat back which define the portable seat. The seat assembly further includes a mounting assembly adapted to be mounted on a vehicle floor. The mounting assembly defines an occupant seating portion for supporting a portion of an occupant of the vehicle seat assembly. The portable seat is adapted to be releasably attached to the mounting assembly.

### BACKGROUND OF THE INVENTION

This invention relates in general to vehicle seats, and in particular to an improved vehicle seat usable outside of the vehicle.

Passenger vehicles include seats for supporting and protecting occupants of the vehicle. A vehicle seat commonly includes a seat back, a seat bottom, and a riser assembly connecting the seat bottom to the vehicle floor. Most seats for passenger vehicles are permanently mounted on the vehicle floor such that they are not intended to be removed from the vehicle, unless for repair and replacement thereof. Some passenger vehicles, such as vans and sport utility vehicles, include removable seats which are intended to be removed by the vehicle consumer. The seats are removably mounted on the floor of the vehicle such that they can be removed from the vehicle to create more storage space within the interior of the vehicle. These removable seats include locking mechanisms mounted on the bottom of the seat riser assemblies and engage with cooperating mounting structures formed in the vehicle floor. After the locking mechanisms are disengaged, the seats can be removed. After removal of the seats, the seats can be stored upright such that the locking mechanisms engage the ground surface where they are stored. However, the locking mechanisms are not constructed to support the weight and movement of an occupant seated on the seat when not engaged with the outside the vehicle. These removable seats are also very heavy and awkward to remove since the entire seat, including the seat back, seat bottom, and riser assemblies are removed from the vehicle.

### SUMMARY OF THE INVENTION

This invention relates to a vehicle seat assembly including a releasable portable seat for use outside of the vehicle. The seat assembly includes a seat back and a seat bottom attached to the seat back which define the portable seat. The seat assembly further includes a mounting assembly adapted to be mounted on a vehicle floor. The mounting assembly defines an occupant seating portion for supporting a portion of an occupant of the vehicle seat assembly. The portable seat is adapted to be releasably attached to the mounting assembly Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a first embodiment of a removable vehicle seat, in accordance with the present invention.

FIG. 2 is a perspective view of the vehicle seat of FIG. 1, wherein the seat back assembly is illustrated being removed from a seat bottom assembly.

FIG. 3 is a perspective view of the seat back assembly of the seat assembly of FIG. 1, wherein the auxiliary seat bottom is shown in its extended position.

FIG. 4 is a perspective view of a second embodiment of a removable vehicle seat, in accordance with the present invention.

FIG. 5 is an exploded perspective view of the vehicle seat assembly of FIG. 4.

FIG. 6 is a side elevational view of the vehicle seat assembly of FIG. 4.

FIG. 7 is a side elevational view of the vehicle seat assembly of FIG. 4, wherein the seat back is shown in its forward tilted position.

FIG. 8 is a partial front view of the seat bottom and mounting portion of the vehicle seat assembly of FIG. 4.

FIG. 9 is a partial front view of the seat bottom and the mounting portion of the vehicle seat assembly of FIG. 8, wherein the seat bottom is being removed from the mounting portion.

FIG. 10 is a perspective view of the rear portion of the seat back of the vehicle seat of FIG. 4 illustrating the lumbar support mechanism.

### DETAILED DESCRIPTION OF THE INVENTION

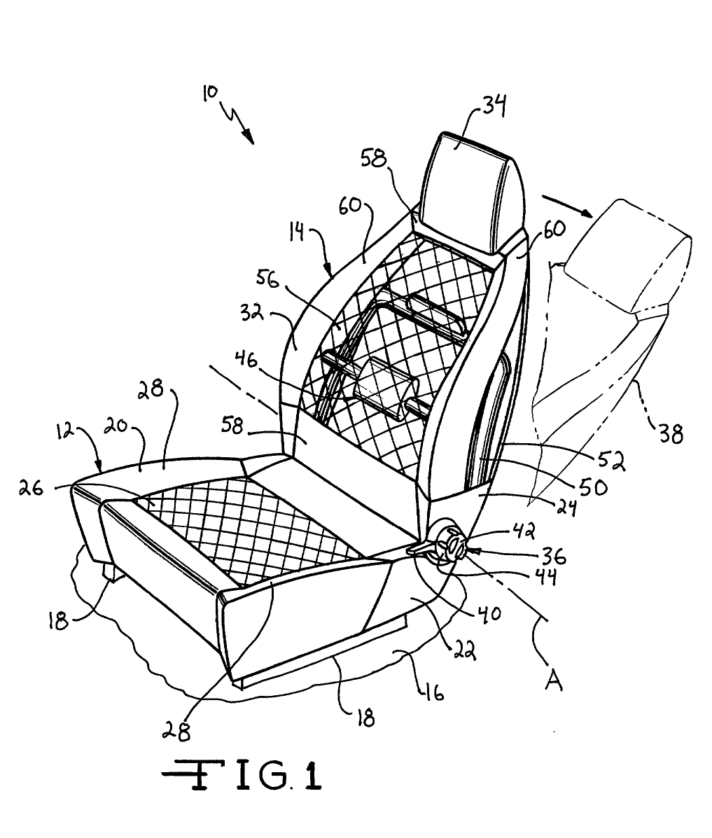

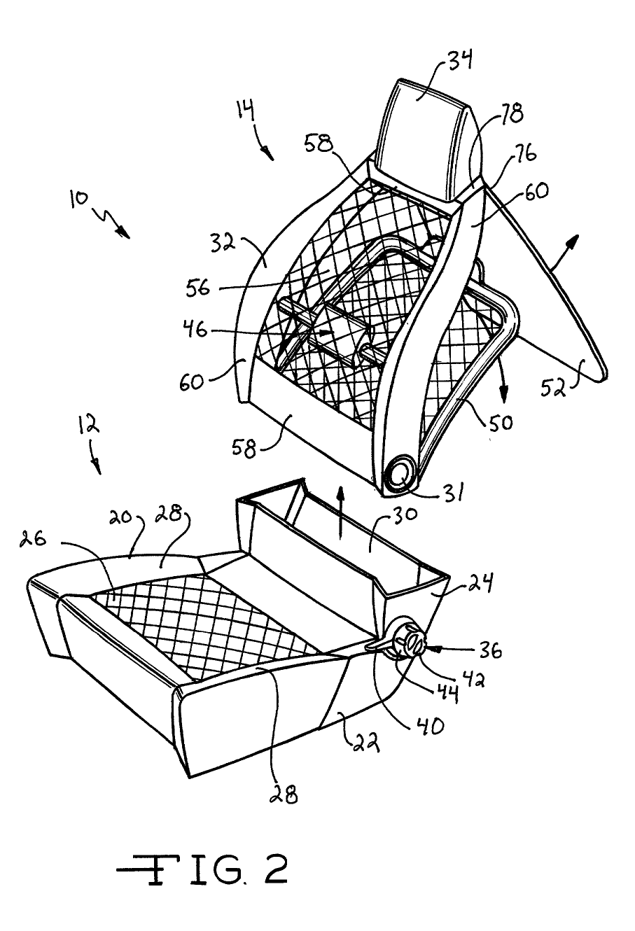

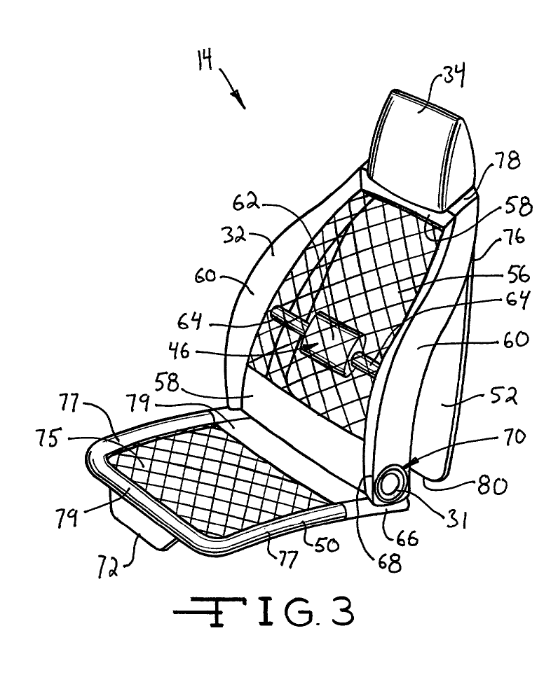

Referring now to the drawings, there is illustrated in FIGS. 1 through 3 a first embodiment of a vehicle seat assembly, indicated generally at 10, in accordance with the present invention. As best shown in FIG. 2, the seat assembly 10 includes a mounting assembly, indicated generally at 12, and a portable seat, indicated generally at 14. As will be explained in detail below, the mounting assembly 12 is intended for permanent attachment to a vehicle floor 16, and the portable seat 14 is releasably attached to the mounting assembly 12 for use to support a seat occupant when the portable seat 14 is used outside of the vehicle, such as in a picnic or tailgating event. Thus, the portable seat 14 is movable between an in vehicle position, as shown in FIG. 1, and an out of vehicle position, as shown in FIGS. 2 and 3.

As stated above, the mounting assembly 12 mounts permanently to the vehicle floor 16, i.e., the mounting assembly 12 is intended to be mounted on the vehicle floor such that the mounting assembly 12 is not normally removed by the consumer unless for repair and replacement thereof. The mounting assembly 12 may be mounted on the vehicle floor 16 by any suitable manner, such as by threaded fasteners (not shown). The mounting assembly 12 may include seat track mechanisms, indicated schematically at 18. The seat track mechanisms 18 include an upper track (not shown) attached to the mounting assembly 12, and a lower track (not shown) attached to the vehicle floor 16. The upper and lower tracks are in sliding engagement with one another and permit linear movement of the mounting assembly 12 in fore and aft directions. Thus, the mounting assembly 12 can be movably mounted on the vehicle floor 16. The seat track mechanisms 18 may include a locking mechanism (not shown) for retaining the relative positions of the upper and lower tracks relative to one another.

The mounting assembly 12 includes a seat bottom 20 attached to the upper seat track. The seat bottom 20 defines an occupant seating portion for supporting an occupant of the seat assembly 10 when the portable seat 14 is attached to the mounting assembly 12. The seat bottom 20 can include any suitable framework, cushion, and trim components for proper support and aesthetic purposes. Since the seat bottom 20 is not removed from the vehicle, the seat bottom 20 can be made of more robust and/or relative heavier materials compared to the materials of the portable seat 14. For example, the seat bottom 20 can be manufactured to withstand relatively large loads, which the seat bottom may be subjected to during a vehicle impact condition. Thus, the occupant seating portion reduces the weight of the removable portable seat 14 since the heavy duty impact resistant framework can be formed with the seat bottom 20 which stays within the interior of the vehicle.

The seat bottom 20 generally includes a lower portion 22 and a receiving portion 24. The lower portion 22 is mounted on the vehicle floor 16 via the seat track mechanisms 18 and is similar in shape and function as a conventional vehicle seat bottom. The lower portion 22 also includes a generally horizontal surface 26 which generally defines the occupant seating portion. The lower portion 22 may includes raised side bolsters 28 for laterally supporting the thigh area of an occupant of the seat assembly 10.

As best shown in FIG. 2, the receiving portion 24 is preferably hollow shaped defining an opening 30 formed in an upper portion thereof. The portable seat 14 is disposed in the hollow portion of the receiving portion 24 when the portable seat 14 is in its in vehicle position, as shown in FIG. 1. The receiving portion 24 can have any suitable shape and is preferably complimentarily shaped with the lower portion of the folded portable seat 14 for an aesthetically pleasing appearance. The seat assembly 10 preferably includes a locking mechanism, schematically shown at 31, to secure the portable seat 14 to the receiving portion 24.

When the portable seat 14 is in its in vehicle position, as shown in FIG. 1, a seat back 32 of the portable seat 14 cooperates with the lower portion 22 of the seat bottom 20 to provide full support of an occupant of the seat assembly 10. The lower portion 22 generally supports the buttocks and upper legs of the occupant, while the seat back 32 generally supports the back and shoulders of the occupant. The seat back 32 may also includes a headrest 34 for supporting the neck and head of an occupant.

Although the receiving portion 24 may be fixedly secured to the lower portion 22 of the seat bottom 20, the receiving portion 24 is preferably attached to the lower portion 22 by a recliner mechanism, indicated schematically at 36, for adjustably positioning the angle between the seat back 32 relative to the lower portion 22 of the seat bottom 20. As indicated by phantom lines 38 in FIG. 1, the seat back 32 can be adjusted to any suitable position about a pivot axis A. The recliner mechanism 36 can be any suitable apparatus for maintaining and selectively pivoting the seat back 32 relative to the seat bottom 20. The recliner mechanism 36 can be manually or power operated. As shown in FIG. 2, the recliner mechanism 36 is preferably mounted on one or both of the receiving portion 24 and lower portion 22 such that the recliner mechanism 36 remains with the seat bottom 20 when the portable seat 14 is removed.

Preferably, the recliner mechanism 36 includes a plurality of controls, knobs, and/or handles for controlling the seat assembly 10 located on one or both sides at the junction of the seat back 32 and the seat bottom 20. For example, the recliner mechanism 36 can include a handle 40 extending therefrom for manually adjusting and securing the recline angle of the seat back 32 relative to the seat bottom 20. A pull handle 42 can be actuated in a lateral direction to operate the locking mechanism 31 to release the portable seat 14 from the receiving portion 24. A rotatable knob 44 surrounding the pull handle 42 may be used to adjust a lumbar support 46 mounted on the seat back 32, as will be discussed in more detail below.

The portable seat 14 generally includes the seat back 32, an auxiliary seat bottom 50, and a cover panel 52. As will be explained below, the auxiliary seat bottom 50 unfolds from a storage position, as shown in FIG. 1 and partially in FIG. 2, and a seating position, as shown in FIG. 3, to provide a support base for the portable seat 14.

The seat back 32 can have any suitable shape and can be made of any suitable materials for supporting an occupant both inside and outside of the vehicle. Preferably, the seat back 32 is lightweight for easy removal. Therefore, a preferred embodiment of the seat back 32, as shown in FIGS. 1 through 3, includes a seating surface 56 made of an elastomeric material which functions as both an occupant support as well as a trim material. The elastomeric material can be stretched between two pairs of parallel frame members 58 and 60. The frame members 58 and 60 define a rectangular outer perimeter of the seat back 32. The frame members 58 and 60 can be covered with padding, cushions, and/or trim material. The elastomeric material can be thinner than the thickness of the frame members 58 and 60 and thus provide a relatively thin and low profile portable seat 14. As a result, the portable seat 14 can be relatively lightweight and thin. The elastomeric material is preferably formed having sufficient strength and elongation to support a vehicle occupant in a sitting position in the seat assembly 10. The elastomeric material should not be rigid or brittle. Some examples of materials suitable for use as the elastomeric material include stretchy woven fabrics made from polypropylene, polyethylene, polyester, or other polymers.

The frame members 58 and 60 can have any suitable shape to provide any desirable contour for the seating surface 56. The seat back 32 may also include the lumbar support 46. As shown in FIG. 3, the lumbar support 46 includes a pad 62 supported by a pair of support members 64 extending from the generally vertical frame members 60. Preferably, the pad 62 of the lumbar support 46 can be positioned along a center vertical axis defined by the seat back 32 by movement of the support members 64 along the length of the frame members 60. Preferably, the pad 62 can also be positioned in a selective fore and aft direction towards or away from the seating surface 56, thus altering the contour of the seating surface 56. The lumbar support 46 can be adjusted by any suitable manner and by any suitable mechanism, such as by manual or power operation.

The auxiliary seat bottom 50 is pivotally attached to the seat back 32. Preferably, a lower portion 66 of the auxiliary seat bottom 50 is pivotally attached to a lower portion 68 of the seat back 32. The auxiliary seat bottom 50 is movable between a storage position, as shown in FIG. 1, and a seating position, as shown in FIG. 3. In the storage position, the auxiliary seat bottom 50 is disposed adjacent the rear side of the seat back 32. In the seating position, the auxiliary seat bottom 50 is preferably pivoted more than 180 degrees but less than about 270 degrees to provide a supporting surface for an occupant and comfortable seat back angle. Of course, the auxiliary seat bottom 50 and the seat back 32 can be positioned at any angle relative to one another. Preferably, the portable seat 14 includes a recliner mechanism, indicated schematically at 70, separate from the recliner mechanism 36. The recliner mechanism 70 adjustably positions the angle between the seat back 32 relative to the auxiliary seat bottom 50. The recliner mechanism 70 can be any suitable apparatus for maintaining and selectively pivoting the seat back 32 relative to the auxiliary seat bottom 50. The recliner mechanism 70 can be manually or power operated. Since the portable seat is not subjected to relative high impact loads as the recliner mechanism 36, the recliner mechanism 70 can be configured lest robust and lightweight.

The auxiliary seat bottom 50 is configured to be placed directly on the ground and preferably has a bottom contoured shape to maintain the portable seat 14 in an upright position. The auxiliary seat bottom 50 may include a ground engaging stand 72 mounted on a front portion 74 thereof. The stand 72 elevates the front portion 74 of the auxiliary seat bottom 50 for a more comfortable seating position.

The auxiliary seat bottom 50 can have any suitable shape and can be made of any suitable materials for supporting an occupant both inside and outside of the vehicle. Preferably, the portable seat 14 is lightweight for easy removal. Therefore, a preferred embodiment of the auxiliary seat bottom 50, as shown in FIGS. 1 through 3, includes a seating surface 75 made of an elastomeric material which functions as both an occupant support as well as a trim material, similar to the seating surface 56 of the seat back 32. The elastomeric material can be stretched between two pairs of parallel frame members 77 and 79. The frame members 77 and one of the frame members 79 can be formed from a U-shaped tubular member. The frame members 77 and 79 define a rectangular outer perimeter of the seat back 32. The frame members 77 and 79 can be covered with padding, cushions, and/or trim material if desired. The elastomeric material can be thinner than the thickness of the frame members 77 and 79 and thus provide a relatively thin and low profile portable seat 14. As a result, the portable seat 14 can be relatively lightweight and thin. The elastomeric material is preferably formed having sufficient strength and elongation to support a vehicle occupant in a sitting position in the seat assembly 10. The elastomeric material should not be rigid or brittle. Some examples of materials suitable for use as the elastomeric material include stretchy woven fabrics made from polypropylene, polyethylene, polyester, or other polymers.

The portable seat 14 preferably includes the optional panel 52 for covering and protecting the auxiliary seat bottom 50 when in its storage position. The panel 52 can have any shape and can be made of any material. An upper portion 76 of the panel 52 is pivotally attached to an upper portion 78 of the seat back 32. When in the storage position, the auxiliary seat bottom 50 is disposed between the panel 52 and the rear side of the seat back 32. The panel 52 is preferably movable to an extended position such that a lower portion 80 of the panel 52 is spaced from the lower portion 58 of the seat back 32, as shown in FIG. 3. The lower portion 80 of the panel 52 can be spaced from the lower portion 58 of the seat back 32 by any distance. In this extended position, the lower portion 80 can engage the ground surface to provide support for the seat back 32 when the portable seat 14 is used as a seat outside of the vehicle.

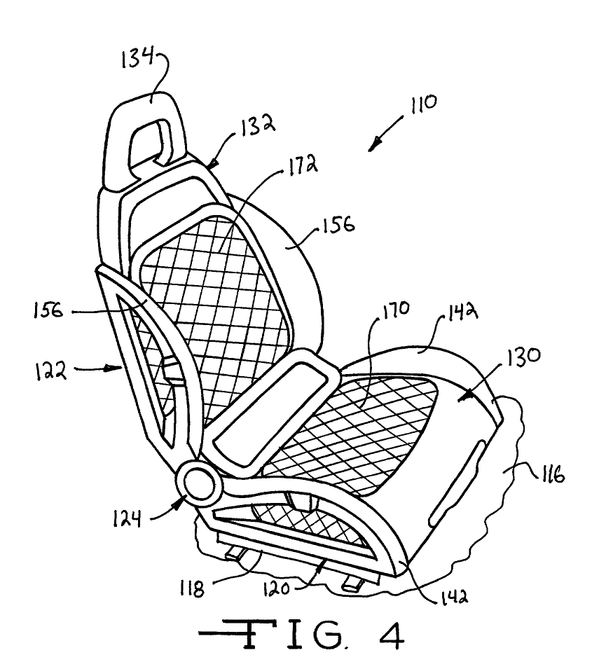

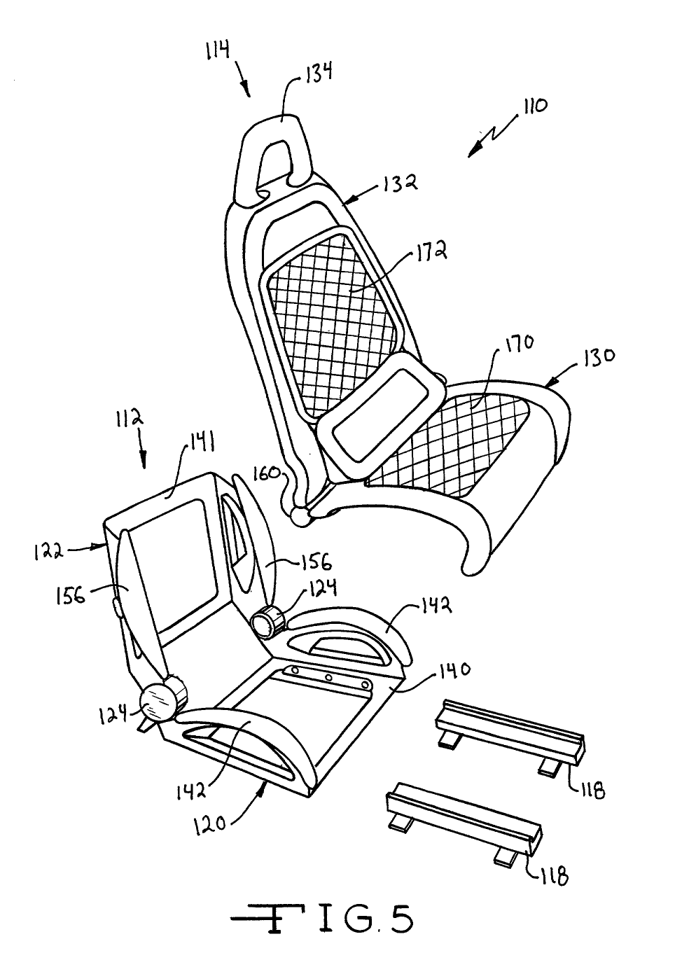

There is illustrated in FIGS. 4 through 10 a second embodiment of a vehicle seat assembly, indicated generally at 110, in accordance with the present invention. As best shown in FIG. 5, the seat assembly 110 includes a mounting assembly, indicated generally at 112, and a portable seat, indicated generally at 114. Similar to the seat assembly 10, the mounting assembly 112 is intended for permanent attachment to a vehicle floor 116, and the portable seat 114 is releasably attached to the mounting assembly 112 for use to support a seat occupant when the portable seat 114 is used outside of the vehicle. Thus, the portable seat 114 is movable between an in vehicle position, as shown in FIG. 4, and an out of vehicle position, as shown in FIG. 5.

The mounting assembly 112 mounts permanently to the vehicle floor 116, i.e., the mounting assembly 112 is intended to be mounted on the vehicle floor 116 such that the mounting assembly 112 is not normally removed by the consumer unless for repair and replacement thereof. The mounting assembly 112 may be mounted on the vehicle floor 116 by any suitable manner, such as by threaded fasteners (not shown). The mounting assembly 112 may include a pair of seat track mechanisms, indicated schematically at 118. The seat track mechanisms 118 include an upper track (not separately shown) attached to the mounting assembly 112, and a lower track (not separately shown) attached to the vehicle floor 116. The upper and lower tracks are in sliding engagement with one another and permit linear movement of the mounting assembly 112 in fore and aft directions. Thus, the mounting assembly 112 can be movably mounted on the vehicle floor 116. The seat track mechanisms 118 may include a locking mechanism (not shown) for retaining the relative positions of the upper and lower tracks relative to one another.

The mounting assembly 112 includes a lower frame member 120 and an upper frame member 122. As discussed below, the frame members 120 and 122 are preferably pivotally attached to one another via a recliner mechanism 124. The lower frame member 120 is attached to the upper seat track. The mounting assembly 112 can include a single recliner mechanism 124 attached at one side thereof, or can include a pair of recliner mechanism, one for each side of the mounting assembly 112.

The portable seat 114 generally includes a seat bottom 130 and a seat back 132. The seat bottom 130 and the seat back define occupant seating portions for supporting an occupant of the seat assembly 110 when the portable seat 114 is attached to the mounting assembly 112 and when the portable seat 114 is released from the mounting assembly 112 and used outside of the vehicle. The seat bottom 130 generally supports the buttocks and upper legs of the occupant, while the seat back 132 generally supports the back and shoulders of the occupant. The seat back 132 may include a headrest 134.

The lower frame member 120 releasably secures the seat bottom 130, and the upper frame member 122 releasably secures the seat back, as will be explained below. The lower frame member 120 and the upper frame member 122 are similar in structure and function. Since the frame members 120 and 122 are not removed from the vehicle, the frame members 120 and 122 can be made of more robust and/or relative heavier materials compared to the materials of the portable seat 114. For example, the frame members 120 and 122 can be manufactured to withstand relatively large loads, which the mounting assembly 112 may be subjected to during a vehicle impact condition.

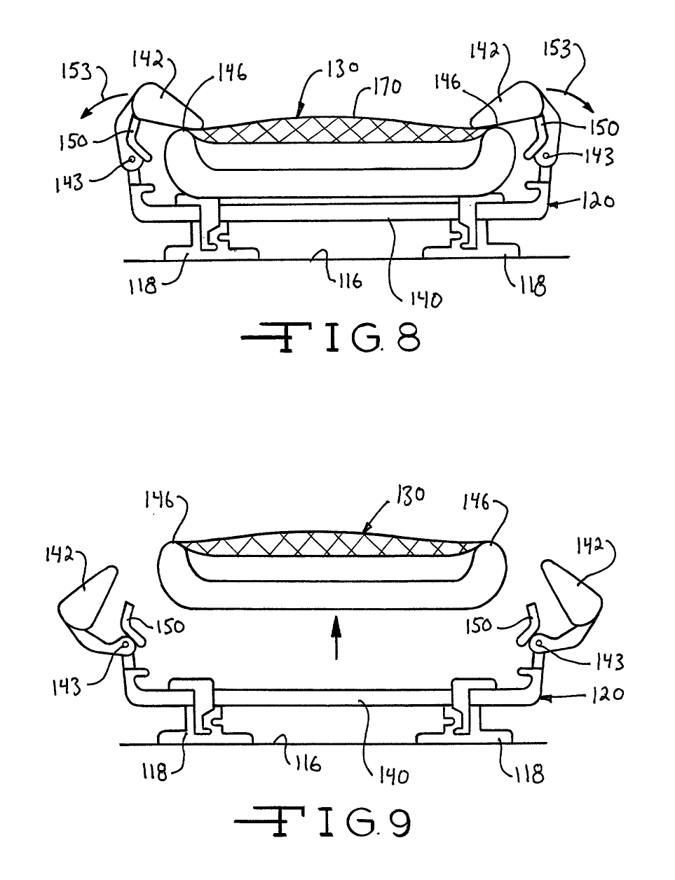

As stated above, the lower frame member 120 and the upper frame member 122 are similar in structure and function and, therefore, only the lower frame member 120 will be described in detail below. As best shown in FIGS. 8 and 9, the lower frame member 120 includes a base frame 140 mounted on the seat track assemblies 118. The base frame 140 can have any suitable shape. In the illustrated embodiment, the base frame 140 is rectangular in shape and generally lies in a horizontal plane. The base frame 141 of the upper frame member 122 is also generally rectangular in shape and generally lies in a plane defined by the slope of the seat back 132. The lower frame member 120 includes a pair of side bolsters 142 which are pivotally mounted on the base frame 140 at pivots 143. The side bolsters 142 are movable between an engaged position, as shown in FIG. 8, and a disengaged position, as shown in FIG. 9. In the engaged position, a portion of the side bolsters 142 are disposed above lateral edges 146 of the seat bottom 130. In the engaged position, the side bolsters 142 securely attach the seat bottom 130 to the lower frame member 120 of the mounting assembly 112 so that the portable seat 114 can be used in the vehicle. The seat bottom 130 is disposed between the side bolsters 142 and the base frame 140. When in the engaged position, the side bolsters 142 define an occupant seating portion which remains with the mounting assembly 112. The side bolsters 142 provide support for the lateral edges of the buttocks and upper legs of the occupant. Preferably, the side bolsters 142 include padding, cushions, and/or trim material. To remove the portable seat 114, the side bolsters 142 are moved to their disengaged position spaced apart from the lateral edges 146 of the seat bottom 130, as shown by directional arrows 153, to permit the portable seat 114 to be lifted off of the base frame 140, as shown in FIG. 9. Preferably, the lower (and upper) frame member 120 include latches, schematically shown at 150, for locking the side bolsters 142 in their engaged positions.

By having the side bolsters 142 function as occupant seating portions, the width of the portable seat 114 can be reduced in size and weight, which reduces the overall weight of the portable seat 114.

Since the upper frame member 122 is similar in function and structure as the lower frame member 120, the upper frame members also preferably includes side bolsters 156 which are pivotally mounted on the upper frame member 122 to be moved between engaged and disengaged positions for selectively securing the seat back 132.

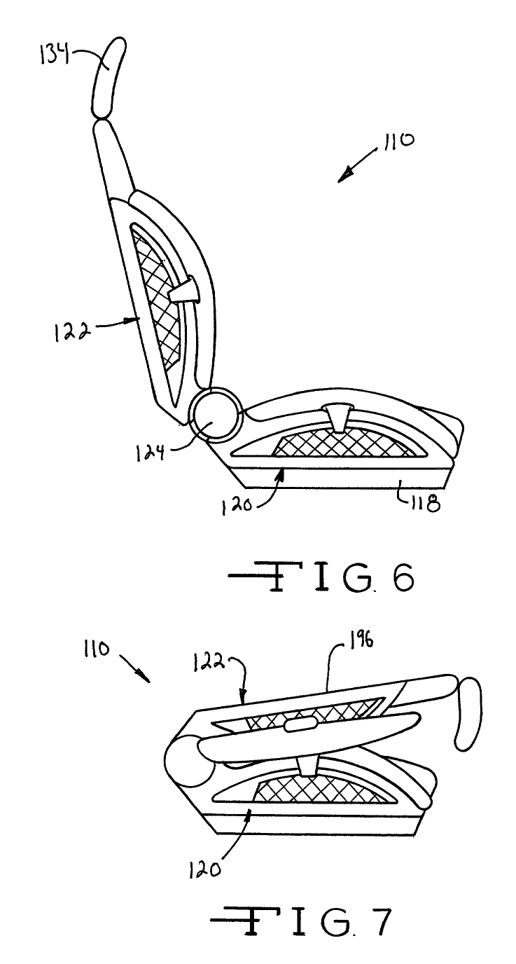

Although the lower and upper frame members 120 and 122 may be fixedly secured to one another, the frame members 120 and 122 are preferably pivotally mounted to each other via the recliner mechanism 124 to adjustably position the angle between the lower frame member 120 and the upper frame member 122. Since the frame members 120 and 122 are attached to the seat bottom 130 and the seat back 132, the recliner mechanism also adjusts the angle between the seat bottom 130 and the seat back 132 when the portable seat 114 is mounted on the mounting assembly 112. The recliner mechanism 124 can be any suitable apparatus for maintaining and selectively pivoting the seat back 132 relative to the seat bottom 130. The recliner mechanism 124 can be manually or power operated. The recliner mechanism 124 can include a plurality of controls, knobs, and/or handles for controlling the seat assembly 110, similar to the recliner mechanism 36 discussed above. As shown in FIG. 7, the recliner mechanism 124 preferably allows adjustment of the recline angle of the seat back 132 such that a rear side 196 is generally horizontally oriented to create a flat load floor.

The seat back 132 and the seat bottom 130 are preferably pivotally attached to one another by a recliner mechanism, indicated schematically at 160, separate from the recliner mechanism 124. The recliner mechanism 160 adjustably positions the angle between the seat back 132 relative to the seat bottom 130. The recliner mechanism 160 can be any suitable apparatus for maintaining and selectively pivoting the seat back 132 relative to the seat bottom 130. The recliner mechanism 160 can be manually or power operated. Since the portable seat 114 is not subjected to relative high impact loads as the recliner mechanism 124, the recliner mechanism 160 can be configured less robust and lightweight.

The seat bottom 130 is configured to be placed directly on the ground and preferably has a bottom contoured shape to maintain the portable seat 114 in an upright position.

The seat back 132 and the seat bottom 130 can have any suitable shape and can be made of any suitable materials for supporting an occupant both inside and outside of the vehicle. Preferably, the seat back 132 and seat bottom 130 are lightweight for easy removal of the portable seat 114. Therefore, a preferred embodiment of the o portable seat 114, includes seating surfaces 170 and 172 for the seat bottom 130 and the seat back 132, respectively, made of an elastomeric material which functions as both an occupant support as well as a trim material. The elastomeric material can be stretched between two pairs of parallel frame members forming the seat back and the seat bottom in a similar manner as the frame members 58 and 60 discussed above. The elastomeric material is preferably formed having sufficient strength and elongation to support a vehicle occupant in a sitting position in the seat assembly 110. The elastomeric material should not be rigid or brittle. Some examples of materials suitable for use as the elastomeric material include stretchy woven fabrics made from polypropylene, polyethylene, polyester, or other polymers.

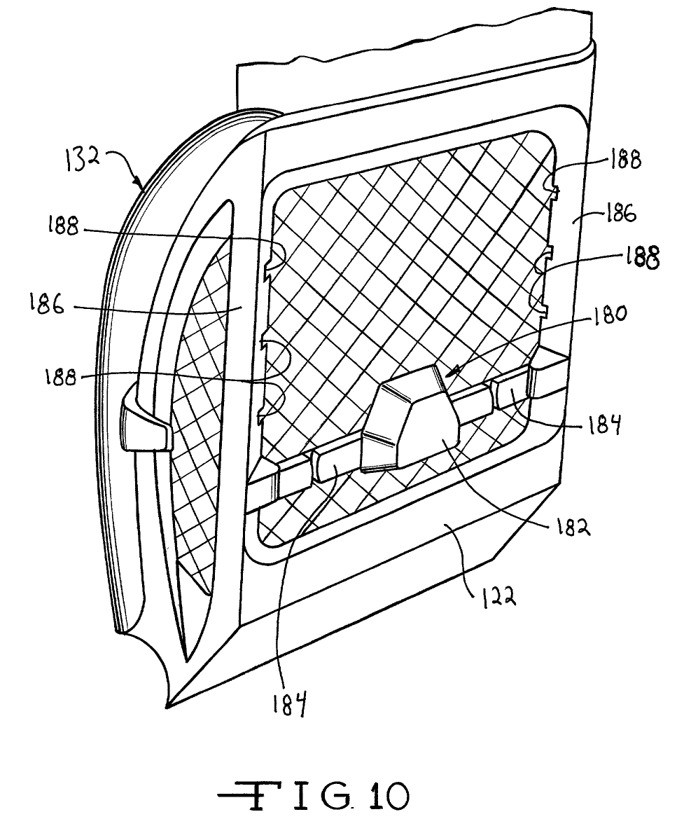

The frame members of the seat bottom 130 and the seat back 132 can have any suitable shape to provide any desirable contour for the seating surface 170 and 172, respectively. The seat back 132 may also include a lumbar support 180 similar to the lumbar support 46 discussed above. As best shown in FIG. 10, the lumbar support 180 includes a pad 182 supported by a pair of support members 184 extending from generally vertical frame members 186 of the upper frame member 122. Preferably, the pad 182 of the lumbar support 180 can be positioned along a center vertical axis defined by the seat back 132 by movement of the support members 184 along the length of the frame members 186. The frame members 186 can include detents 188 formed in the frame members 186 for locating and positively supporting the vertical position of the lumbar support 180. Preferably, the pad 182 can also be positioned in a selective fore and aft direction towards or away from the seating surface 172, thus altering the contour of the seating surface 172. The lumbar support 180 can be adjusted by any suitable manner and by any suitable mechanism, such as by manual or power operation.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle seat assembly comprising:
a seat back;
a seat bottom attached to said seat back to define a portable seat; and
a mounting assembly adapted to be mounted on a vehicle floor, said mounting assembly defining an occupant seating portion for supporting a portion of an occupant of the vehicle seat assembly, wherein said portable seat is adapted to be releasably attached to said mounting assembly such that said portable seat is adapted to be used for supporting an occupant outside of the vehicle.

2. The seat assembly of claim 1, wherein said seat back is attached to said seat bottom via a recliner mechanism for adjustably positioning the angle between said seat back relative to said seat bottom.

3. The seat assembly of claim 1, wherein said mounting assembly includes:
a receiving portion for releasably attaching said portable seat to said mounting assembly;
a lower portion mounted on the vehicle floor; and
a second recliner mechanism attached to said receiving portion and said lower portion for adjusting the angle between said seat back relative to said mounting portion.

4. The seat assembly of claim 3, wherein said seat back is attached to said seat bottom via another recliner mechanism for adjustably positioning the angle between said seat back relative to said seat bottom.

5. The seat assembly of claim 1 including a seat track mechanism mounted on the vehicle floor and attached to said mounting assembly for selectively moving said mounting assembly relative to the vehicle floor in fore and aft directions.

6. The seat assembly of claim 1, wherein said seat bottom defines an outer perimeter, and wherein said seat assembly includes an elastomeric material stretched between said outer perimeter to provide support for an occupant.

7. The seat assembly of claim 1, wherein said seat back defines an outer perimeter, and wherein said seat assembly includes an elastomeric material stretched between said outer perimeter to provide support for an occupant.

8. The vehicle seat assembly of claim 1, wherein said seat back includes a movable lumbar support.

9. The vehicle seat assembly of claim 1 including a locking mechanism for releasably securing said portable seat to said mounting assembly.

10. The seat bottom of claim 1, wherein said occupant seating portion is defined as a second seat bottom for supporting an occupant.

11. The seat bottom of claim 1, wherein said seat bottom is pivotally attached to said seat back and is movable between a storage position in which said seat bottom is adjacent a rear side of said seat back, and a seating position in which a front portion of said seat bottom is spaced from said seat back to provide support for an occupant when used outside of the vehicle as said portable seat.

12. The seat assembly of claim 11, wherein said seat bottom pivots relative to said seat back by more than 180 degrees between said storage position and said seating position.

13. The seat assembly of claim 10, wherein said seat back includes a panel pivotally attached to said seat back for covering said seat bottom when said seat bottom is in its storage position.

14. The seat assembly of claim 13, wherein said seat bottom is disposed between said panel and a rear side of said seat back when said seat bottom is in said storage position.

15. The seat assembly of claim 13, wherein said panel is pivotally attached to an upper portion of said seat back, and wherein said panel is movable to an extended position such that a lower portion of said panel is spaced from a lower portion of said seat back, and wherein said lower portion of said panel is adapted to engage a ground surface to provide support for said seat back when said portable seat is used outside the vehicle.

16. The seat assembly of claim 1, wherein said occupant seating portion is defined as side bolsters disposed adjacent lateral edges of said seat bottom when said seat bottom is attached to said mounting portion.

17. The seat assembly of claim 16, wherein each of said side bolsters are movable between an engaged position such that side bolsters extend over said lateral edges of said seat bottom, and a disengaged position such that said side bolsters are spaced from said lateral edges of said seat bottom to permit said portable seat to be lifted off said mounting assembly.

18. The seat assembly of claim 16, wherein each side bolster includes a latch for locking said side bolsters in said seating position.

19. A vehicle seat assembly comprising:
a seat back;
a seat bottom attached to said seat back to define a portable seat;
a mounting assembly mounted on a vehicle floor, wherein said portable seat is adapted to be releasably attached to said mounting assembly such that said portable seat is adapted to be used for supporting on occupant outside of the vehicle;
a first recliner mechanism connected to said seat back and said seat bottom for adjustably positioning said seat back relative to said seat bottom; and
a second recliner mechanism connected to said mounting assembly and said portable seat for adjustably positioning said seat back relative to said mounting assembly.

20. The seat assembly of claim 19 including a seat track mechanism mounted on the vehicle floor and attached to said mounting assembly for selectively moving said mounting assembly relative to the vehicle floor in fore and aft directions.

21. The seat assembly of claim 19, wherein said seat bottom defines an outer perimeter, and wherein said seat assembly includes an elastomeric material stretched between said outer perimeter to provide support for an occupant.

22. The seat assembly of claim 19, wherein said seat back defines an outer perimeter, and wherein said seat assembly includes an elastomeric material stretched between said outer perimeter to provide support for an occupant.
